(19) United States
(12) Patent Application Publication
(10) Pub. No.: US 2025/0328747 A1
(43) Pub. Date: Oct. 23, 2025

(54) POOL EQUIPMENT WITH IMPROVED PAIRING CAPABILITIES

(71) Applicant: ZODIAC POOL CARE EUROPE, Belberaud (FR)

(72) Inventors: Badr Bouaddi, Belberaud (FR); Arnaud Besnier, Beaupuy (FR)

(21) Appl. No.: 19/181,580

(22) Filed: Apr. 17, 2025

Related U.S. Application Data
(60) Provisional application No. 63/637,667, filed on Apr. 23, 2024.

(51) Int. Cl. G06K 19/06; E04H 4/14; G09G 3/36

(52) U.S. Cl. CPC G06K 19/06037; E04H 4/14; G09G 3/36; G09G 2354/00; G09G 2380/04

(57) ABSTRACT

Pool equipment for a swimming pool or spa includes a processor and a memory coupled to the processor. The memory includes instructions executable by the processor to generate a QR code for the pool equipment. The pool equipment may include one or more of a control box, a water chlorinator, a pump, a heat pump, and automatic pool cleaner, or any other pool equipment.

### REFERENCE TO RELATED APPLICATION

The application claims the benefit of and priority to U.S. Provisional Patent Application No. 63/637,667, filed on Apr. 23, 2024, and entitled POOL EQUIPMENT WITH IMPROVED PAIRING CAPABILITIES, the content of which is hereby incorporated by reference in its entirety.

### FIELD OF THE INVENTION

The invention relates to swimming pools and spas, and more particularly, although not necessarily exclusively, to systems and methods for communicating with equipment of the swimming pools and spas.

### BACKGROUND OF THE INVENTION

Swimming pools and spas are commonly used for a variety of recreational and other purposes and include various associated equipment such as but not limited to control boxes, water chlorinators, pumps, heat pumps, automatic pool cleaners, sensors, pool lights, etc. The equipment associated with the swimming pool and spa thus may vary greatly, may perform various functions, and may obtain various information related to the swimming pool or spa. The equipment associated with the swimming pool or spa may be electronically coupled with an external electronic device, such as a user device, computer, phone, etc., via various wireless communication techniques to transfer information (e.g., to receive information from the pool equipment and/or to provide information to the pool equipment). However, traditional pairing processes to establish the wireless communication between the pool equipment and the external device require significant time, effort, and knowledge from a user and/or may require external assistance to properly connect with the equipment of the pool or spa.

### SUMMARY

The terms “invention,” “the invention,” “this invention” and “the present invention” used in this patent are intended to refer broadly to all of the subject matter of this patent and the patent claims below. Statements containing these terms should be understood not to limit the subject matter described herein or to limit the meaning or scope of the patent claims below. Embodiments of the invention covered by this patent are defined by the claims below, not this summary. This summary is a high-level overview of various embodiments of the invention and introduces some of the concepts that are further described in the Detailed Description section below. This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

According to certain embodiments, pool equipment for a swimming pool or spa includes an onboard QR code generator.

According to some embodiments, pool equipment for a swimming pool or spa includes a liquid crystal display screen configured to display a QR code.

According to various embodiments, pool equipment for a swimming pool or spa includes a processor and a memory coupled to the processor, and the memory includes instructions executable by the processor to generate a QR code for the pool equipment.

Pool equipment for a swimming pool or spa may include a display, a processor operably coupled to the display, and a memory coupled to the processor. The memory includes instructions executable by the processor to generate a QR code for the pool equipment and display the QR code on the display.

In some embodiments, pool equipment for a swimming pool or spa includes a processor and a memory coupled to the processor. The memory includes instructions executable by the processor to receive a user input by the pool equipment, generate a QR code for the pool equipment responsive to the received user input, and display the QR code on a display of the pool equipment.

According to some embodiments, a non-transitory computer readable storage medium includes a plurality of instructions executable by one or more processors, the plurality of instructions including instructions which, when executed by the one or more data processors, cause the one or more data processors to perform actions including generating a QR code for a piece of pool equipment and displaying the QR code on a display of the pool equipment.

A method includes receiving, by a processor of a piece of pool equipment, user input from a user; generating, by the processor, a QR code for the piece of pool equipment responsive to the user input; and displaying the QR code on a display of the piece of pool equipment.

According to certain embodiments, pool equipment for a swimming pool or spa includes a display and a processor, wherein the processor generates a QR code for the pool equipment during a pairing process of the pool equipment with an external device or system and display the QR code on a display of the pool equipment.

A pool system may include a plurality of pieces of equipment, each piece of equipment including a processor configured to generate a QR code unique to the piece of equipment.

Various implementations described in the present disclosure can include additional systems, methods, features, and advantages, which cannot necessarily be expressly disclosed herein but will be apparent to one of ordinary skill in the art upon examination of the following detailed description and accompanying drawings. It is intended that all such systems, methods, features, and advantages be included within the present disclosure and protected by the accompanying claims.

### BRIEF DESCRIPTION OF THE DRAWINGS

The features and components of the following figures are illustrated to emphasize the general principles of the present disclosure. Corresponding features and components throughout the figures can be designated by matching reference characters for the sake of consistency and clarity.

FIG. 1 illustrates a pool system with pool equipment according to embodiments.

FIG. 2 illustrates the pool system of FIG. 1 with additional pool equipment according to embodiments.

### DESCRIPTION OF THE INVENTION

Described herein are pool systems and associated methods with improved pairing capabilities between pool equipment and external systems or devices such as but not limited to user devices, smartphones, the internet, etc. The pool equipment with improved pairing capabilities may be various equipment of the pool system as desired, such as but not limited to control boxes, water chlorinators, pumps, heat pumps, automatic pool cleaners, sensors, pool lights, etc. In some embodiments, the pool equipment may include a display on or associated with the pool equipment. While various displays may be utilized, in some embodiments, the display may be a liquid crystal display.

In certain embodiments, the pool equipment may include an onboard QR code generator, which may be integrated into firmware of the pool equipment itself. In various embodiments, the pool equipment may generate a QR code for the pool equipment. The generated QR code may include data that identifies the pool equipment and data about one or more of a pairing process, maintenance information, installation information, operation information, pairing with a sub-system, historical information about the pool equipment, and/or production information. In other embodiments, the QR code may include additional data as desired, such as but not limited location data of the pool equipment. In various embodiments, the systems and methods described herein may include generating the QR code responsive to user input, such as but not limited to a communication from an external device and/or input received on the pool equipment.

In some embodiments, the systems and methods described herein may include generating a QR code by the pool equipment responsive to user input and displaying the QR code on a display of or associated with the pool equipment. In various embodiments, the systems and methods described herein may include causing the pool equipment to cease displaying the QR code after a predetermined time period and/or responsive to user input and/or responsive to determining a completion of a pairing process. In one non-limiting example, the pool equipment may generate and display the QR code at least when going through a pairing process of a pool cleaner with an external device, the cloud, and/or the internet.

Pool equipment with the QR code generator and/or QR codes described herein may provide improved user access to the pool equipment through a pairing process. The QR code may further display with ease various other data such as but not limited to installation data, maintenance data, production data, operation data, reports, pairing with a sub-system, combinations thereof, and/or other data as desired. Various other benefits and advantages may be realized with the systems, devices, and methods provided herein, and the aforementioned advantages should not be considered limiting.

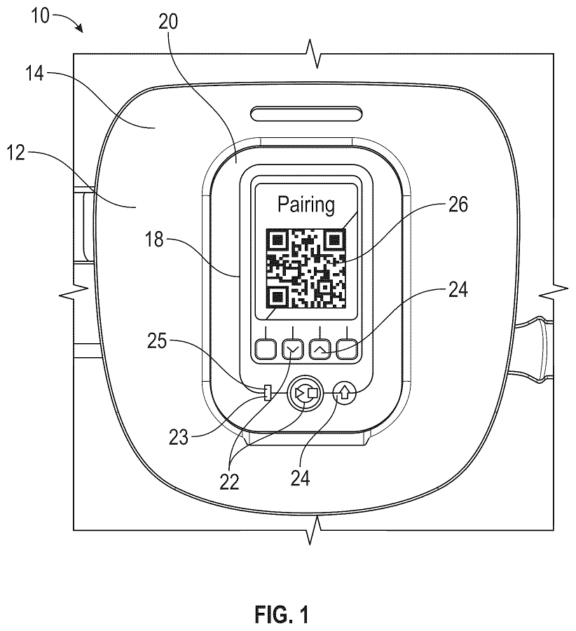

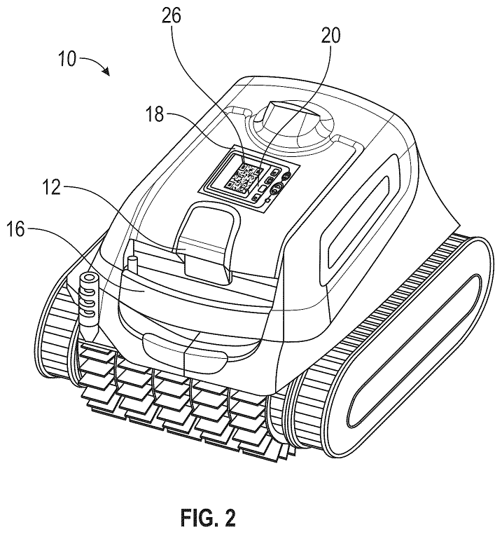

FIGS. 1 and 2 illustrate a pool system 10 with pool equipment 12 according to embodiments. As illustrated, the pool equipment 12 may include a control box 14 (FIG. 1) and/or an automatic pool cleaner 16 (FIG. 2). However, the number and type of pool equipment 12 included with the pool system 10 should not be considered limiting, and in various embodiments, the pool system 10 may include any number of pool equipment 12 and/or various types and/or combinations of pool equipment 12 as desired. As non-limiting examples, the pool system 10 may include a single piece of pool equipment 12 or a plurality of (two or more) pieces of pool equipment 12. In embodiments with a plurality of pieces of pool equipment 12, the pool equipment 12 may be of a same type, of different types, and/or combinations thereof. Non-limiting examples of pool equipment include, but are not limited to, control boxes, water chlorinators, pumps, heat pumps, automatic pool cleaners, sensors, pool lights, combinations thereof, and/or other equipment as desired.

In certain embodiments, the pool equipment 12 includes a human machine interface 18 with at least a display 20 on and/or associated with the pool equipment and for displaying information to a user. Various types of displays 20 may be utilized as desired. In one non-limiting example, the display 20 is a liquid crystal display. Optionally, the human machine interface 18 includes one or more input feature 22 for receiving input from a user and/or one or more output features 23 for providing output (e.g., the generated QR code) to a user. Non-limiting examples of input features 22 include a touchscreen, the display 20, virtual buttons 24, physical buttons, keys, switches, combinations thereof, and/or other input features as desired. Non-limiting examples of output features 23 include the display 20, visual indicators 25, speakers, combinations thereof, and/or other output features as desired.

In various embodiments, onboard the pool equipment 12 is a control system with one or more processing units and/or one or more memory devices. The processing unit may be various suitable processing devices or combinations of devices including but not limited to one or more application specific integrated circuits, processors, digital signal processors, digital signal processing devices, programmable logic devices, field programmable gate arrays, processors, controllers, micro-controllers, microprocessors, other electronic units, and/or a combination thereof.

The one or more memory devices may be any machine-readable medium that can be accessed by the processor, including but not limited to any type of long term, short term, volatile, nonvolatile, or other storage medium, and is not to be limited to any particular type of memory or number of memories, or type of media upon which memory is stored. Moreover, as disclosed herein, the term “storage medium,” “storage” or “memory” can represent one or more memories for storing data, including read only memory (ROM), random access memory (RAM), magnetic RAM, core memory, magnetic disk storage mediums, optical storage mediums, flash memory devices and/or other machine readable mediums for storing information. The term “machine-readable medium” includes, but is not limited to, portable or fixed storage devices, optical storage devices, wireless channels, and/or various other storage mediums capable of storing that contain or carry instruction(s) and/or data.

In certain embodiments, the pool equipment 12 may include a communication module such that the pool equipment may wirelessly communicate with one or more external devices, such as a user device, cloud, external device, and/or as otherwise desired, using various wireless communication technology such as but not limited to Bluetooth, RF, IR, Wi-Fi, cellular, combinations there, and/or as otherwise desired. Traditionally, pairing, or establishing wireless communication, between the pool equipment 12 and the external device has required significant time, effort, and knowledge from a user and/or may require external assistance to properly connect with the equipment of the pool or spa.

In view of the limitations of traditional approaches, the pool equipment 12 is configured to generate and display a QR code 26 to facilitate pairing between the pool equipment 12 and an external device and/or the transfer of data from the pool equipment 12 to the external device.

In some embodiments, the pool equipment 12 includes a QR code generator integrated into the control system or firmware onboard the pool equipment 12. The QR code 26 generated by the QR code generator may be displayed on the pool equipment 12, such as but not limited to the display 20 of the human machine interface 18. In one non-limiting example, the QR code 26 may be displayed on a liquid crystal display 20 with sufficient definition for capture by a camera, such as but not limited to a camera on the external device.

The QR code 26 may include various data as desired, such as but not limited to device identification, data that identifies the pool equipment, data about a pairing process, maintenance information, installation information, operation information, pairing with a sub-system, location data, environmental data, and/or production information, combinations thereof, and/or other data as desired. In other embodiments, other information about the pool equipment 12 and/or related processes may be provided within the QR code 26. In one non-limiting example, the QR code 26 may include pairing processes or steps for guiding the user how to establish wireless communication or pairing with the pool equipment 12. Depending on the type of data provided, the QR code 26 may be static or dynamic. As a non-limiting example, a QR code 26 generated for guiding a user through a pairing process optionally may be static (e.g., the steps required may not change) while a QR code 26 generated to provide maintenance or operation information may be dynamic and changing as the maintenance or operation information changes. When the QR code 26 is scanned and decoded by the external device, the data may be displayed on a screen of the external device. In some embodiments, displaying the data obtained by the QR code may be facilitated by an application running on the external device.

As mentioned, the QR code generator may be integrated into the firmware of the pool equipment 12 such that the pool equipment 12 generates one or more QR codes 26 for the pool equipment 12 and displays the generated QR code(s) 26 on the display 20. In some embodiments, the control system of the pool equipment 12 may generate one or more QR codes 26 responsive to user input by the pool equipment 12. Such user input may be received, for example, by the human machine interface 18, or otherwise obtained by the pool equipment 12. As a non-limiting example, the pool equipment 12 may generate the QR code 26 responsive to a detected proximity or presence of the external device relative to the pool equipment 12. In one non-limiting example, the received input may include an indication, e.g., by selecting an input feature on the human machine interface 18, that an external device has started a pairing process with the pool equipment 12 and/or a pairing process should be initiated. In another non-limiting example, the received user input may include a prompt or indication that other data is requested by the external device, such as but not limited to maintenance information, installation information, operation information, information regarding pairing with a sub-system, location data, environmental data, and/or production information, combinations thereof, and/or other data as desired.

In some embodiments, the QR code 26 may be generated based on the type of user input received. As non-limiting examples, user input requesting pairing information or indicating an initiation of a pairing process may generate a first QR code 26 with associated pairing data, and user input requesting operation information may generate a second QR code 26 with associated operation information data. In other embodiments, a plurality of types of data may be included with the QR code 26. As a non-limiting example, user input requesting pairing assistance may generate a QR code 26 with pairing data as well as system status data (e.g., operation status of the pool equipment 12, maintenance data of the pool equipment 12, etc.). In other embodiments, the pool equipment 12 need not generate and display the QR code 26 responsive to received input.

Optionally, the pool equipment 12 may cease displaying the QR code 26 on the display 20 responsive to one or more conditions. Non-limiting examples of such conditions may include, but are not limited to, a predetermined time period, supplemental received user input, a determination by the pool equipment 12 of a completion of a pairing (or other) process, combinations thereof, and/or as otherwise desired.

A method of facilitating communication between the pool equipment 12 and one or more external devices may include receiving, by a processor of the pool equipment 12, user input from a user, generating, by the processor, the QR code 26 for the piece of pool equipment 12 responsive to the user input, and displaying the QR code 26 on the display 20 of the pool equipment 12.

Exemplary concepts or combinations of features of the invention may include:
A. Pool equipment for a swimming pool or spa, wherein the pool equipment comprises an onboard QR code generator.
B. Pool equipment for a swimming pool or spa comprising a liquid crystal display screen configured to display a QR code.
C. Pool equipment for a swimming pool or spa, the pool equipment comprising a processor and a memory coupled to the processor, wherein the memory comprises instructions executable by the processor to generate a QR code for the pool equipment.
D. Pool equipment for a swimming pool or spa, the pool equipment comprising a display, a processor operably coupled to the display, and a memory coupled to the processor, wherein the memory comprises instructions executable by the processor to generate a QR code for the pool equipment and display the QR code on the display.
E. Pool equipment for a swimming pool or spa, the pool equipment comprising a processor and a memory coupled to the processor, wherein the memory comprises instructions executable by the processor to:
   i. receive a user input by the pool equipment;
   ii. generate a QR code for the pool equipment responsive to the received user input; and
   iii. display the QR code on a display of the pool equipment.
F. Pool equipment according to any preceding or subsequent statement or combination of statements, wherein the pool equipment comprises one or more of a control box, a water chlorinator, a pump, a heat pump, and automatic pool cleaner, or any other pool equipment.
G. Pool equipment according to any preceding or subsequent statement or combination of statements, wherein the pool equipment is configured to receive the user input on the pool equipment.
H. Pool equipment according to any preceding or subsequent statement or combination of statements, wherein the pool equipment comprises a human machine interface comprising at least a display.
I. Pool equipment according to any preceding or subsequent statement or combination of statements, wherein the human machine interface further comprises means for receiving input from a user.
J. Pool equipment according to any preceding or subsequent statement or combination of statements, wherein the means for receiving input from the user comprises a button, touchscreen, key, or switch.
K. Pool equipment according to any preceding or subsequent statement or combination of statements, wherein the QR code contains data that identifies the pool equipment and data about one or more of a pairing process, maintenance information, installation information, operation information, pairing with a sub-system, or production information.
L. Pool equipment according to any preceding or subsequent statement or combination of statements, wherein the received user input comprises an indication that an external device has started a pairing process with the pool equipment.
M. Pool equipment according to any preceding or subsequent statement or combination of statements, wherein the instructions further comprise instructions executable by the processor to cease displaying the QR code after a predetermined time period and/or responsive to user input and/or responsive to determining a completion of a pairing process.
N. Pool equipment according to any preceding or subsequent statement or combination of statements, wherein the instructions further comprise instructions executable by the processor to generate a plurality of QR codes.
O. A non-transitory computer readable storage medium comprising a plurality of instructions executable by one or more processors, the plurality of instructions comprising instructions which, when executed by the one or more data processors, cause the one or more data processors to perform actions including:
   i. generating a QR code for a piece of pool equipment; and
   ii. displaying the QR code on a display of the pool equipment.
P. A method comprising:
   i. receiving, by a processor of a piece of pool equipment, user input from a user;
   ii. generating, by the processor, a QR code for the piece of pool equipment responsive to the user input; and
   iii. displaying the QR code on a display of the piece of pool equipment.
Q. Pool equipment for a swimming pool or spa comprising a display and a processor, wherein the processor is configured to generate a QR code for the pool equipment during a pairing process of the pool equipment with an external device or system and display the QR code on a display of the pool equipment.
R. A pool system comprising a plurality of pieces of equipment, each piece of equipment comprising a processor configured to generate a QR code unique to the piece of equipment.

These examples are not intended to be mutually exclusive, exhaustive, or restrictive in any way, and the invention is not limited to these example embodiments but rather encompasses all possible modifications and variations within the scope of any claims ultimately drafted and issued in connection with the invention (and their equivalents). For avoidance of doubt, any combination of features not physically impossible or expressly identified as non-combinable herein may be within the scope of the invention. Further, although applicant has described devices and techniques for use principally with APCs, persons skilled in the relevant field will recognize that the present invention conceivably could be employed in connection with other objects and in other manners. Finally, references to “pools” and “swimming pools” herein may also refer to spas or other water containing vessels used for recreation, training, or therapy and for which cleaning of debris is needed or desired.

That which is claimed:

1. Pool equipment for a swimming pool or spa, the pool equipment comprising a processor and a memory coupled to the processor, wherein the memory comprises instructions executable by the processor to generate a QR code for the pool equipment.

2. The pool equipment of claim 1, wherein the pool equipment further comprises a liquid crystal display screen configured to display a QR code.

3. The pool equipment of claim 2, wherein the memory further comprises instructions executable by the processor to display the QR code on the display.

4. The pool equipment of claim 1, wherein the memory further comprises instructions executable by the processor to:
i. receive a user input by the pool equipment;
ii. generate the QR code for the pool equipment responsive to the received user input; and
iii. display the QR code on a display of the pool equipment.

5. The pool equipment of claim 4, wherein the received user input comprises an indication that an external device has started a pairing process with the pool equipment.

6. The pool equipment of claim 1, wherein the pool equipment is configured to receive the user input on the pool equipment.

7. The pool equipment of claim 1, wherein the pool equipment comprises a human machine interface comprising at least a display.

8. The pool equipment of claim 7, wherein the human machine interface further comprises means for receiving input from a user.

9. The pool equipment of claim 8, wherein the means for receiving input from the user comprises a button, touchscreen, key, or switch.

10. The pool equipment of claim 1, wherein the QR code contains data that identifies the pool equipment and data about one or more of a pairing process, maintenance information, installation information, operation information, pairing with a sub-system, or production information.

11. The pool equipment of claim 1, wherein the pool equipment comprises one or more of a control box, a water chlorinator, a pump, a heat pump, and automatic pool cleaner, or any other pool equipment.

12. The pool equipment of claim 1, wherein the instructions further comprise instructions executable by the processor to cease displaying the QR code after a predetermined time period and/or responsive to user input and/or responsive to determining a completion of a pairing process.

13. The pool equipment of claim 1, wherein the instructions further comprise instructions executable by the processor to generate a plurality of QR codes.

14. Pool equipment for a swimming pool or spa comprising a display and a processor, wherein the processor is configured to generate a QR code for the pool equipment during a pairing process of the pool equipment with an external device or system and display the QR code on a display of the pool equipment.

15. The pool equipment of claim 14, wherein the pool equipment comprises one or more of a control box, a water chlorinator, a pump, a heat pump, and automatic pool cleaner, or any other pool equipment.

16. A non-transitory computer readable storage medium comprising a plurality of instructions executable by one or more processors, the plurality of instructions comprising instructions which, when executed by the one or more data processors, cause the one or more data processors to perform actions including:
generating a QR code for a piece of pool equipment; and
displaying the QR code on a display of the pool equipment.

17. The non-transitory computer readable storage medium of claim 16, wherein the plurality of instructions further comprise instructions causing the one or more data processors to perform actions including:
receiving user input from a user;
generating the QR code for the piece of pool equipment responsive to the user input; and
displaying the QR code on a display of the piece of pool equipment.

18. The non-transitory computer readable storage medium of claim 16, wherein the plurality of instructions further comprise instructions causing the one or more data processors to perform actions including:
cease displaying the QR code after a predetermined time period and/or responsive to user input and/or responsive to determining a completion of a pairing process.

19. The non-transitory computer readable storage medium of claim 16, wherein the QR code contains data that identifies the pool equipment and data about one or more of a pairing process, maintenance information, installation information, operation information, pairing with a sub-system, or production information.

20. The non-transitory computer readable storage medium of claim 16, wherein the pool equipment comprises one or more of a control box, a water chlorinator, a pump, a heat pump, and automatic pool cleaner, or any other pool equipment.
